(19) United States
(12) Patent Application Publication
(10) Pub. No.: US 2009/0182869 A1
(43) Pub. Date: Jul. 16, 2009

(54) VIEWING EFFECT MEASURING SYSTEM, AND MEASURING METHOD AND MEASURING TERMINAL THEREOF

(76) Inventors: Masayuki Sakata, Matsudo (JP); Kenya Nishiki, Chigasaki (JP); Maki Mori, Kawasaki (JP); Erika Tanaka, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/344,690

(22) Filed: Dec. 29, 2008

(30) Foreign Application Priority Data
Dec. 28, 2007 (JP) 2007-339386

(51) Int. Cl. G06F 15/173

(52) U.S. Cl. 709/224

(57) ABSTRACT

A viewing effect measuring system is provided. A user terminal performs a content output process for receiving content from a content delivery apparatus and outputting the content, a Web site displaying process for accepting a request to access a Web site, while the content are outputted, accessing the Web site via the network, and displaying the Web site in such a manner as available for browsing, and a measurement information sending process for establishing an association between Web site specifying information which identifies the Web site as to which the access is requested, and content specifying information which identifies the content being outputted when the access is performed, and sending information of the association as viewing information to a measuring server. The measuring server receives the viewing information from the user terminal and sends the information to a Web server of the Web site as measurement information.

### INCORPORATION BY REFERENCE

This application claims priority based on a Japanese patent application, No. 2007-339386 filed on Dec. 28, 2007, the entire contents of which are incorporated herein by reference.

### BACKGROUND OF THE INVENTION

The present invention relates to a technique for measuring a relevancy between viewing of content and accessing to a Web site.

Along with the development of a merger between broadcast equipment and communications equipment, a terminal for receiving broadcasting is getting provided with a function for accessing a network such as the Internet. According to a method disclosed in the Japanese Unexamined Patent Application Publication No. 2005-115790, for instance, this type of terminal may display the content such as broadcast programs being received, concurrently with extracting and displaying information relating to the content from the electronic program guide or the like, allowing a user to make a selection from displayed character strings, images, and the like. Then, according to the item being selected, coupling is established with a Web site via the Internet, and the site is displayed in such a manner as available for browsing. On this occasion, it is advantageous for an operator of the Web site, if it is possible to measure what scene/advertisement of what content being broadcasted has prompted the user to access the Web site.

### SUMMARY OF THE INVENTION

However, in the method disclosed in the Japanese Unexamined Patent Application Publication No. 2005-115790, the Web site being accessible is limited to the Web site that is related to the program being delivered. With this technique, it is not possible to accurately obtain the relevancy between the broadcasted content, and the Web site which the user wanted to view based on the broadcasted content.

The present invention provides a technique for measuring the relevancy between viewing of a certain content and accessing to a Web site based on the content being viewed, without restricting the Web site being accessible.

In order to solve the problem above, one of the preferable aspects of the present invention is directed to a viewing effect measuring system incorporating a user terminal, a measuring server, and a Web server. The user terminal performs a content output process for receiving content from a content delivery apparatus for delivering the content, and outputting the content, a Web site displaying process for accepting a request to access a Web site, while the content are outputted by the content output process, accessing the Web site via the network, and displaying the Web site in such a manner as available for browsing, and a measurement information sending process for establishing an association between Web site specifying information which identifies the Web site as to which the access is requested, and content specifying information which identifies the content being outputted when the access is performed, and sending the information of the association as viewing information to the measuring server. The measuring sever performs a process for receiving the viewing information from the user terminal, and sending the information to the Web server of the Web site as measurement information.

The user terminal may add a viewing ID to the viewing information for identifying the viewing content serving as a trigger of access, and transmit the viewing information together with the viewing ID to the measuring server. Then, the measuring server is allowed to generate the measurement information, assuming that the viewing information items each having an identical viewing ID have the same content that triggered the access, among the viewing information items collected from the user terminal.

The present invention enables a measurement of relevancy between viewing of the content and browsing of the Web site, and such information of measurement is supplied to a provider of the Web site or the content, thereby allowing an effective usage of the information.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 illustrates one example of the configuration of the viewing effect measuring system according to the first embodiment;

FIG. 2 illustrates one example of the user information table;

FIG. 3 illustrates one example of the user terminal information table;

FIG. 4 illustrates one example of the contract site table;

FIG. 5 illustrates one example of the content information table;

FIG. 6 illustrates one example of the viewing information table;

FIG. 7 illustrates one example of the screen configuration according to the first embodiment;

FIG. 8 illustrates one example of the viewing effect measuring process flow according to the first embodiment;

FIG. 9 illustrates one example of the measurement information according to the first embodiment;

FIG. 10 illustrates one example of the viewing information table;

FIG. 11 illustrates one example of the Web access table;

FIG. 12 illustrates one example of the viewing effect measuring process flow according to the second embodiment;

FIG. 13 illustrates one example of the measurement information according to the second embodiment;

FIG. 14 illustrates one example of the configuration of the viewing effect measuring system according to the third embodiment; and

FIG. 15 illustrates one example of the viewing effect measuring process flow according to the third embodiment.

### DETAILED DESCRIPTION OF THE EMBODIMENTS

### First Embodiment

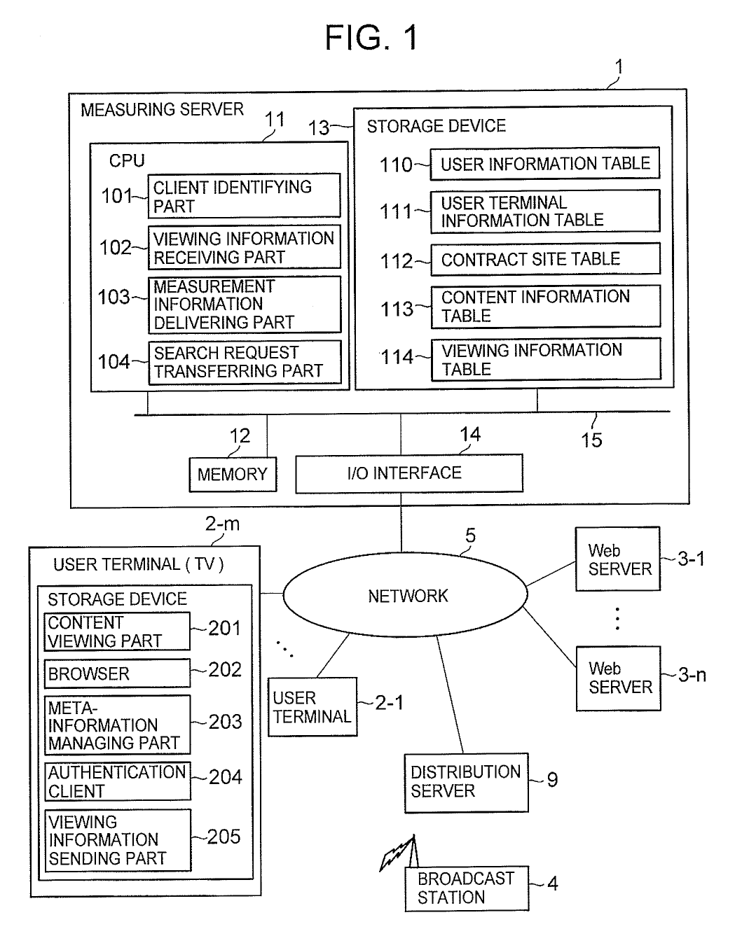

FIG. 1 illustrates the viewing effect measuring system according to a first embodiment.

The viewing effect measuring system incorporates a measuring server 1 for measuring a viewing effect and providing measurement information, a user terminal 2 (2-1 to 2-m), a Web server 3 (3-1 to 3-n) for providing Web content, and broadcast station 4 (in other words “content delivery apparatus”) for delivering content such as broadcast programs (simply referred to as “content”) to the user terminal 2.

Those elements above, except the broadcast station 4, are coupled with one another via a network 5, such as the Internet. It is to be noted here that the broadcast station 4 may be an apparatus coupled with the network 5, such as a distribution server 9. In the case above, the distribution server 9 delivers the content to the user terminal 2 via the network 5.

The measuring server 1 incorporates a CPU (Central Processing Unit) 11, a memory 12, a storage device 13, an I/O interface 14, and a bus 15 coupling the elements above. The I/O interface 14 may be coupled with a display device, an input device (a keyboard, or the like), a drive for mounting a portable storage medium, a network controller for controlling data transfer with the network 5, and the like.

The CPU 11 incorporates as functional elements, a client identifying part 101, a viewing information receiving part 102, a measurement information delivering part 103, and a search request transferring part 104. The CPU 11 reads programs for implementing the functional elements 101 to 104 as described above, from the storage device 13, stores the read programs into the memory 12, and executes the programs, so as to implement these functional elements on a computer.

Therefore, the storage device 13 stores the programs to implement these functional elements 101 to 104, in addition to an OS (Operating System). The storage device 13 further stores a user information table 110, a user terminal information table 111, a contract site table 112, content information table 113, and a viewing information table 114.

The client identifying part 101 manages information stored in the user information table 110 and the user terminal information table 111, as membership information of the user terminal 2, and further the client identifying part 101 performs a process such as authentication of the user terminals 2-1 to 2-m.

The viewing information receiving part 102 receives from the user terminal 2, information which specifies an access to the Web site having been performed by a user during the viewing, and performs processing such as storing the information in the viewing information table 114.

The measurement information delivering part 103 transmits the measurement information to the Web server 3 of the Web site under contract, at regular intervals or in response to a request from the Web server 3 of the Web site under contract.

The search request transferring part 104 transmits to the Web server 3, a search request received from the user terminal 2, according to the Uniform Resource Locator (URL) of a sending destination.

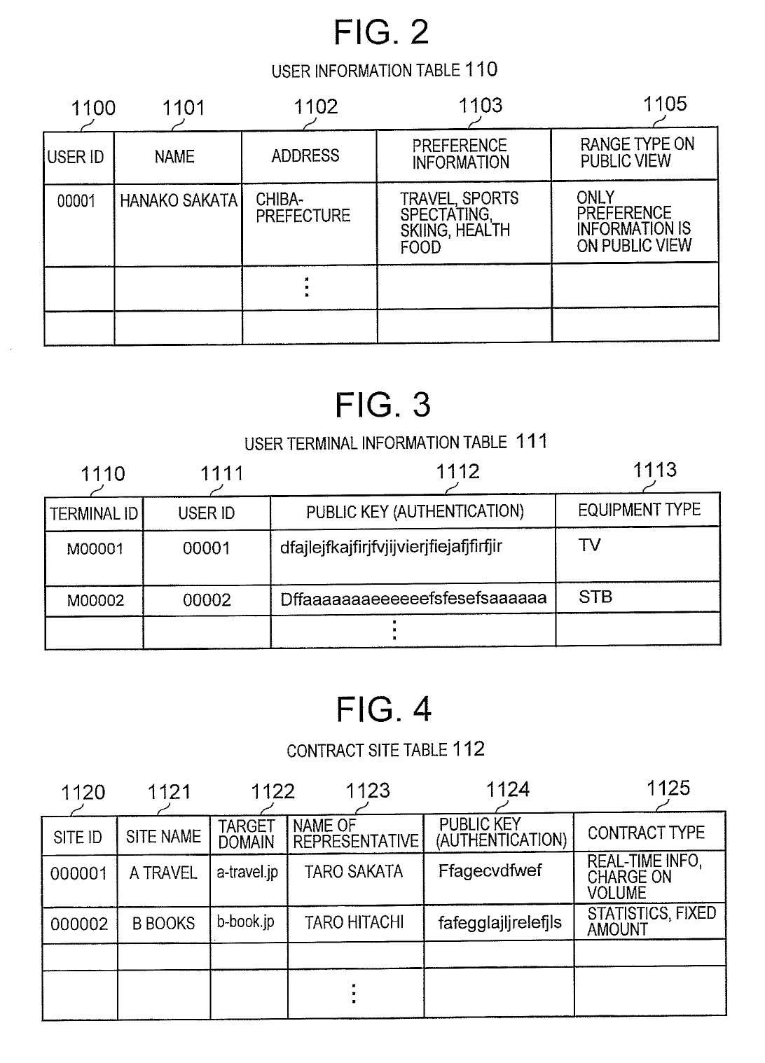

FIG. 2 illustrates one example of the user information table 110. The user information table 110 stores information (profile information) as to each user, regarding an attribute and characteristics of the user. In other words, the user information table 110 stores with respect to each record, user identification information (ID) 1100, a full name 1101, an address 1102, information regarding preference (preference information) 1103, a range type on public view 1105, and the like. The range type on public view 1105 defines a range of information available for public view, among the user information stored in the user information table 110.

FIG. 3 illustrates one example of the user terminal information table 111. The user terminal information table 111 is a table for storing information to identify and authenticate the user terminals 2-1 to 2-m, and stores as to each terminal, information regarding the terminal. In other words, the user terminal information table 111 stores in each record, a terminal ID 1110, a user ID 1111 of the user who uses the terminal, a public key 1112, an equipment type 1113, and the like. The public key 1112 is a key used for authentication.

FIG. 4 illustrates one example of the contract site table 112. The contract site table 112 is a table for storing information of the Web site already under contract, and each record is made up of items, such as a site ID 1120, a site name 1121, a target domain 1122, a representative name 1123, a public key 1124, and a contract type 1125. The representative name 1123 is a name of person who manages and operates the site. The public key 1124 is a key used for authentication.

The contract type 1125 indicates a description of the contract for transmitting the measurement information to the Web server 3. By way of example, in the case where the contract type 1125 indicates “real-time information, charge on volume”, the measuring server 1 transmits the measurement information in real time at every time when the user terminal 2 accesses the Web site, to the Web server 3 being associated. Then, the amount of charge is calculated according to how many times the measurement information is provided. If the contract type is “statistics, fixed amount”, the measuring server 1 performs statistical processing to obtain the measurement information from the viewing information being collected, and sends the measurement information being obtained to the Web server 3 being associated, at a predetermined timing. Then, irrespective of the number of times the measurement information is provided, a fixed amount (a predetermined amount) is calculated as the amount of charge.

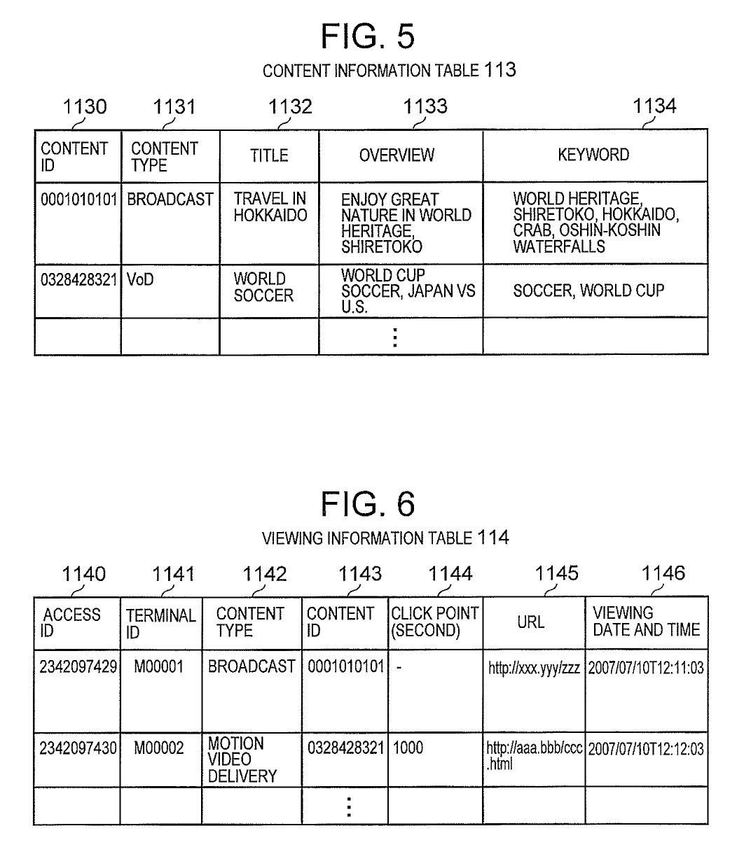

FIG. 5 illustrates one example of the content information table 113. The content information table 113 is a table for storing information regarding the content, and each record is made up of items such as a content ID 1130, a content type 1131, a title 1132, an overview 1133, and a keyword 1134. The content type 1131 includes “broadcast” and “VoD” (video on demand; on-demand video content delivery).

It is to be noted that in the present embodiment, the content ID is an identifier to uniquely identify the broadcast content, such as G-code (registered trademark).

FIG. 6 illustrates one example of the viewing information table 114. The viewing information table 114 is a table for storing access information from the user terminal 2 to the Web server 3, and information of the content that are viewed at the time when the access is made. In other words, a record is set every time when the Web server 3 is accessed, and each record includes an access ID 1140, a terminal ID 1141, a content type 1142, a content ID 1143, a click point 1144, an access URL 1145, a viewing date and time 1146, and the like. The access ID 1140 is identification information for identifying each access.

The terminal ID 1141 indicates a terminal ID of the user terminal that makes the access. The content type 1142 is a type of the content being viewed at the time of the access (in other words, “content outputted when the search request is made”). The content ID 1143 indicates the content ID of the content that are being viewed at the time when the access is made.

A click point 1144 indicates a time when the Web site is accessed, with respect to the date and time of starting reproduction of the content, in the case where the content represent moving picture. Therefore, when the content represent a static image, nothing in particular is stored in the click point 1144. The access URL 1145 indicates the URL of the Web site to which an access request is made.

The viewing date and time 1146 indicates the date and time when the content are being viewed, and when the search request is made.

It is to be noted that in the present embodiment, the functional elements 101-103 are implemented by the programs, but those elements may be implemented by hardware.

Each of the functions of the measuring server 1 may not only be established on one apparatus, but also implemented in multiple apparatuses, in which each of the processes are distributed. In addition, each of the functions may be presented by more than one company.

The programs executed by the CPU 11 may be stored in advance in the memory 12 or in the storage device 13, or stored from another apparatus into the memory 12 or in the storage device 13, via a portable storage medium that is mounted in a drive. Further alternatively, such programs may be stored from another apparatus into the memory 12 or in the storage device 13, via communication lines coupled with the I/O interface 14, or via a carrier wave, a digital signal, or the like, propagating through the communication lines.

An explanation will be made with reference to FIG. 1 again. In the present embodiment, the user views the content delivered from the broadcast station 4, by using the user terminal 2, accesses the Web server 3, and utilizes the Web service provided by the Web server 3. In other words, the user terminal 2 functions as a TV set as well as functioning as a Web browser.

The user terminal 2 includes, as its functional elements, a content viewing part 201 for outputting broadcasting content such as broadcast programs, in such a manner as available for viewing, a browser 202 for accessing a Web site such as the Web server 3 via the network 5 to utilize an image, a moving picture, text data, and the like, a meta-information managing part 203 for obtaining from the Web site, the electronic program guide and meta information of moving pictures, via a broadcasting wave or the network 5, and supplying such information to the user, an authentication client 204 for holding a secret key peculiar to each of the terminals and performing an authentication process with the measuring server 1 if needed, and a viewing information sending part 205 for sending the information relating to the content and the access to the Web site, to the measuring server 1.

The user terminal 2 is made up of a computer available for outputting the content being received, and accessing and displaying the Web site. In other words, the user terminal 2 is made up of a computer incorporating a CPU, a memory, a storage device, an input device, a display device, an I/O interface, and the like. The CPU executes predetermined programs stored in the storage device, thereby implementing each of the functional elements on the computer. It is to be noted those functions may be implemented by hardware.

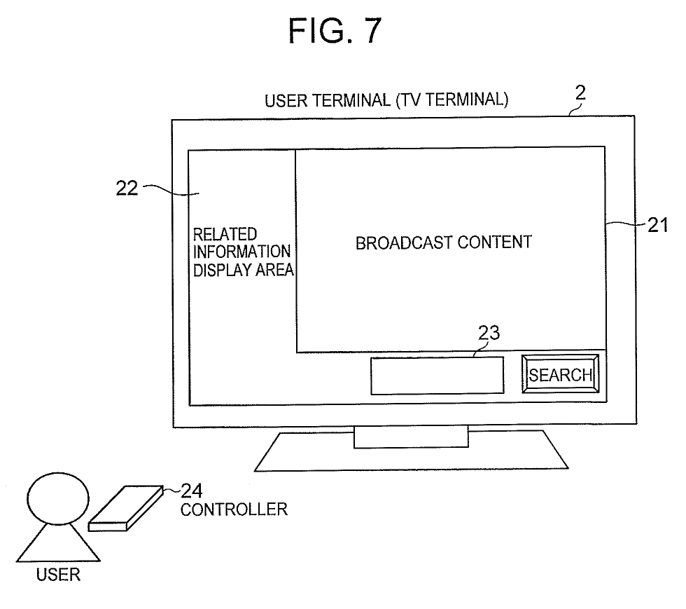

FIG. 7 illustrates a screen configuration example of the user terminal 2. The user terminal 2 displays the content being received such as broadcast program in a content display area 21, and information relating to the content is extracted from the electronic program guide or the like, to be displayed in the related information display area 22. In addition, the user terminal 2 accepts from the user via a search string input column 23, a character string that the user wants to select or retrieve, by using a controller 24 or the like, attached to the user terminal 2.

A browser 202 of the user terminal 2 conducts a search using the character string inputted by the user as a key, by way of the Internet, and displays the content being retrieved in the related information display area 22, the content display area 21, or full-screen.

It is to be noted that each of the functions of the user terminal 2 may not be structured in one apparatus, but may be implemented by distributing each processing unit in multiple apparatuses.

Hereinafter, an explanation will be made as to a flow of the operations of the viewing effect measuring system. Here, a viewing information provision service will be taken as an example for the explanation. In this service, a target user terminal 2 has both an Internet coupling function and a broadcast wave receiving and displaying function, and the measuring server 1 collects access information to a Web site during the content viewing, and provides the viewing information to a Web server 3 being a server of the Web site that has contracted with a carrier who operates the measuring server 1.

As for the user information table 110, the user terminal information table 111, and the contract site table 112 of the measuring server 1, it is assumed that each of the information items in those tables is registered as a precondition, according to an already known method. It is further assumed that each of the information items in the content information table 113 is registered from the electronic program guide, or the like, for instance.

In the network 5, in order to avoid danger in security caused by a malicious third person, such as tapping, tampering, spoofing, or the like, it is desirable to employ an encryption communication technique such as the Secure Socket Layer (SSL), so as to perform information encryption and server authentication. Such ensuring of security is performed as appropriate.

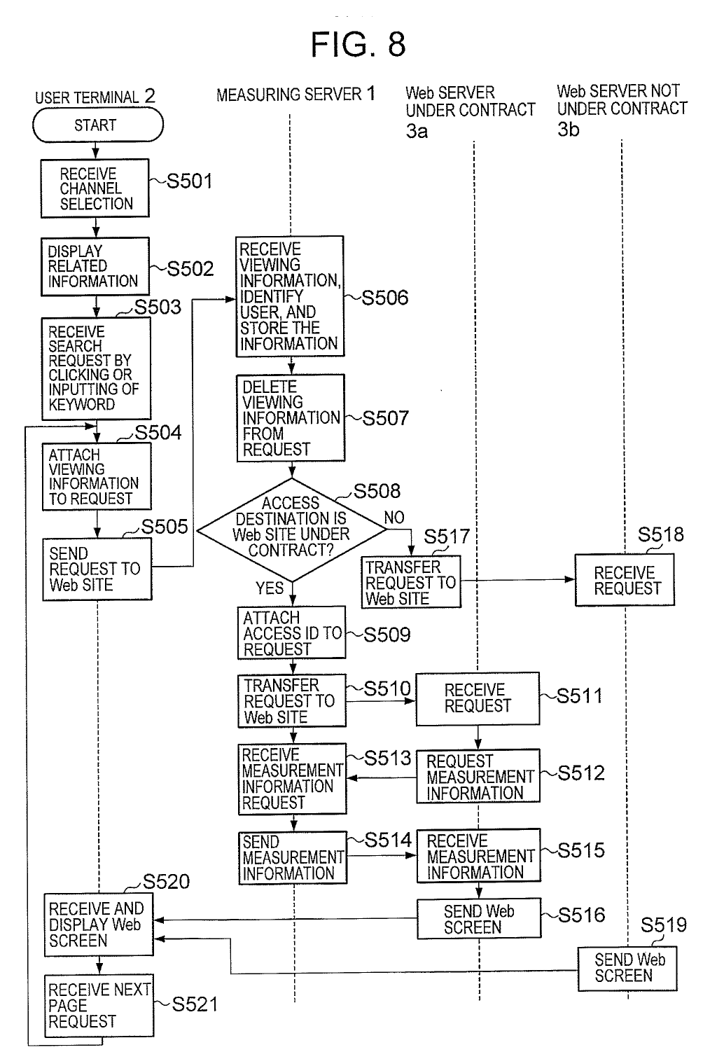

FIG. 8 is a flow diagram of characteristic operations of the viewing information measuring system according the present embodiment. In this flow, the measuring server 1 collects the viewing information from the user terminal 2, and provides the viewing information to the Web server 3a of the Web site under contract.

Here, it is assumed that the Web server 3 includes a Web server 3a of the Web site under contract, and a Web server 3b of the Web site that is not under contract.

Upon receipt of a channel selection request from the controller 24 or the like (S501), the content viewing part 201 of the user terminal 2 performs a process for displaying the content being requested, and simultaneously, according to an already known method, displays the information related to the content in the related information display area 22 (S502).

In addition, the browser 202 of the user terminal 2 accepts from a user, a selection of a character string or an image of the related information being displayed, or a direct input of URL, thereby accepting a search request of the content of the Web site (S503). Here, it is to be noted that the character string or the image is linked with the URL, and the browser 202 specifies the URL being a destination of the search request, according to the character string or the image being selected.

The viewing information sending part 205 of the user terminal 2 generates viewing information, and attaches the viewing information to the search request to the Web server 3 (S504).

Specifically, the viewing information sending part 205 generates the viewing information including, a terminal ID of itself (which corresponds to the terminal ID 1141 of the viewing information table 114 in FIG. 6), a type of the content displayed when the search request is accepted (which corresponds to the content type 1142), the content ID of the content (which corresponds to the content ID 1143), a clock time when the search request is made while outputting the content (which corresponds to the click point 1144) and a viewing date and time (which corresponds to the viewing date and time 1146). Then, the generated viewing information is attached to the search request. It is assumed here that the search request includes the URL of the sending destination.

Next, the viewing information sending part 205 transmits the search request to the Web server 3 (S505). On this occasion, the viewing information sending part 205 sets the measuring server 1 as a proxy server in the browser 202, and sends the search request to the Web server 3 via the measuring server 1. It is to be noted that since the viewing information is attached to the search request, the user terminal 2 sends the viewing information to the measuring server 1 together with the search request.

The viewing information receiving part 102 of the measuring server 1 receives from the user terminal 2, the search request to the Web server 3 and the viewing information. On this occasion, the client identifying part 101 identifies the user terminal 2 according to an already known method.

Furthermore, the viewing information receiving part 102 adds a record to the viewing information table 114. Then, the viewing information receiving part 102 issues and stores an access ID 1140 and further stores the viewing information being received and the URL included in the search request (S506). Accordingly, one record is added to the viewing information table 114 as shown in FIG. 6, the record storing each of the information items 1140 to 1146.

Next, the search request transferring part 104 deletes the viewing information attached to the search request being received (S507). In addition, the search request transferring part 104 determines whether or not the Web server 3 being the destination of the search request is the Web server 3a, depending on whether or not the domain of the URL 1145 of the destination agrees with the target domain 1122 of any of the records in the contract site table 1122 (S508). If the Web server 3 being the destination of the search request is not the Web server 3a of the site under contract (No in S508), the search request transferring part 104 transmits the search request to the Web server 3b according to the URL 1145 (S517). On this occasion, the Web server 3b of the Web site, corresponding to the URL, that is not under contract receives the search request (S518), and sends to the user terminal 2, a corresponding Web screen (S519).

If the Web server 3 being the destination of the search request is the Web server 3a of the Web site that is under contract (Yes in S508), the search request transferring part 104 attaches the access ID 1140 to the search request (S509). Then, according to the URL 1145, the search request transferring part 104 transmits the search request, to which the access ID is attached, to the Web server 3a of the site under contract (S510).

Upon receipt of the search request (S511), the Web server 3a of the contract site being associated with the URL acquires the access ID 1140 from the search request, and requests to the measuring server 1 to send measurement information, using the access ID 1140 as a key (S512).

The measuring server 1 receives the request for transmitting the measurement information (S513), and authenticates the Web server 3a being the request source, according to an already known method. Then, the measurement information delivering part 103 acquires the viewing information being associated, from the viewing information table 114 using the access ID 1140 as a key, and acquires the information of the content having been viewed and the information of the user who has been viewing, from the content information table 113, the user terminal information table 111, and the user information table 110, and returns such information items as the measurement information, to the Web server 3a (step 514).

Detailed explanation will be given in the following. The measurement information delivering part 103 firstly specifies a record in which associated viewing information is stored, using the access ID 1140 as a key, from the viewing information table 114. Then, the content ID 1143 stored in the specified record is identified. Then, the measurement information delivering part 103 specifies, from the content information table 113, a record being stored in which the content ID 1130 is identical to the specified content ID 1143. Accordingly, the measurement information delivering part 103 acquires from the information of the specified record, the content information (the content type 1131, title 1132, overview 1133, and key word 1134) that was being viewed when the user issued the search request.

The measurement information delivering part 103 specifies from the user terminal information table 112, a record having the terminal ID 1110 identical to the terminal ID 1141 stored in the record that is specified from the viewing information table 114. Then, the measurement information delivering part 103 specifies the user ID 1111 from the specified record, and the associated user information (the name 1101, address 1102, and preference information 1103), referring to the user information table 110.

It is to be noted here that the information regarding the user is limited to the information as to which the user gives permission to the measuring server 1 in advance to be available for public view. In other words, the measurement information delivering part 103 acquires only the information defined in the range type on public view 1105. For example, when “preference information only” is defined in the range type on public view 1105, the measurement information delivering part 103 does not acquire the name 1101, the address 1102, and the like, but acquires only the preference information 1103.

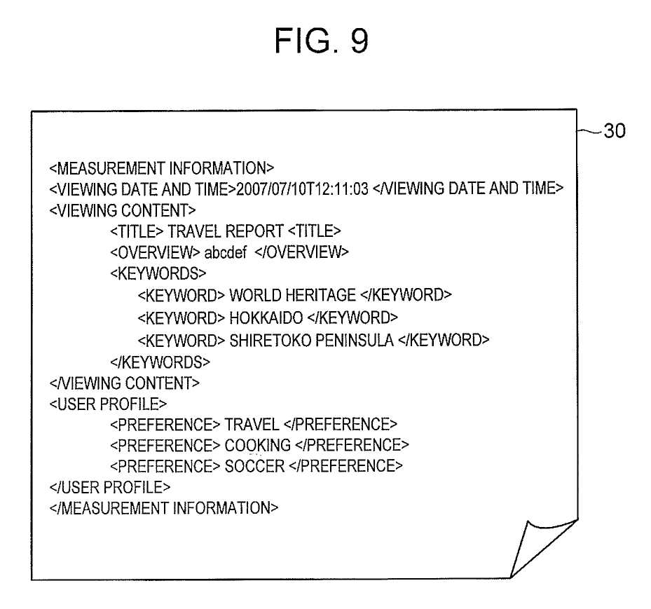

FIG. 9 illustrates one example of the measurement information 30 acquired according to the procedure as described above.

In receipt of the measurement information 30 (step 515), the Web server 3 generates a Web screen which is optimum for the user, based on the measurement information 30 being received, and transmits the Web screen to the user terminal 2 (step 516).

By way of example, the Web server 3 stores a Web screen for each preference (travel, cooking, soccer, or the like) in its own storage device in advance. Then, the Web server 3 reads from the storage device, the Web screen associated with the preference information included in the measurement information 30, and transmits the Web screen to the user terminal 2.

The user terminal 2 receives the Web screen associated with the search request and displays the screen on the display device (S520). Hereinafter, the user may select a link icon or the like on the Web screen to request the next screen (step 521), the viewing information sending part 205 of the user terminal 2 returns the process to step S504, attaches the viewing information to the request once again, and transmits the search request with the viewing information to the measuring server 1 (step 505).

If the channel of the viewing content is changed, the user terminal 2 restarts the process from S501.

If a search request designating a new URL is made, the user terminal restarts the process from S503.

As discussed so far, according to the present embodiment, the measuring server 1 collects information of the user regarding an access to a Web site while viewing the content, and when the Web site is under contract with the carrier operating the measuring server 1, it is possible to provide the viewing measurement information to the Web server 3a of the Web site. Therefore, the Web server 3a under contract is allowed to display on the user terminal an optimum screen customized for each user, and the measurement information (viewing information) is effectively utilized.

It is further possible for the measuring server 1 to aggregate the measurement information within a certain period of time, and provide the information as statistical information to the Web server 3.

It is to be noted that in S508, the search request transferring part 104 may further determine whether or not the contract type 1125 is “contracted to provide information in real time”. Such determination is made by judging whether or not the contract type 1125 is “real-time information”, which is stored in a record in the contract site table 112, the record having the same domain with the destination URL 1145. Then, only when the contract is made in such a manner as providing the information in real time, the measurement information delivering part 103 provides the measurement information in real time, according to the process from S509 as described above. On the other hand, if the contract is not made in such a manner as providing the information in real time, the measurement information delivering part 103 collects the measurement information within a predetermined period of time, and sends such collected information to the Web server 3.

By way of example, the following procedure will be taken, in order to provide statistical information such as what kind of content have frequently been viewed, when a particular Web server 3a is accessed within a certain period of time (e.g., one week). The measurement information delivering part 103 extracts a record out of the data in the viewing information table 114, the record having the viewing date and time 1146 being within the predetermined period of time, and the URL 1145 corresponding to the URL of this particular Web server 3. Then, the number of the records being extracted is counted to generate the statistical information.

In the first embodiment, the preference information used as the user's preference information 1103 is registered by the user in advance. However, the present invention is not limited to this configuration. The carrier who operates the measuring server 1 or the Web server 3 may use the viewing information of the user, so as to automatically generate or automatically update the user's preference information 1103.

By way of example, the measuring server 1 may hold in advance a “preference category table” in which a preference category (e.g., “travel”) is associated with a key word related to the preference category (e.g., “world heritage”, “Hokkaido”, and “Shiretoko”) Then, the measurement information delivering part 103 conducts a search for the content ID 1143 of the content viewed by each user in the predetermined period of time (e.g., one week), by using the user information table 110, the user terminal information table 111, and the viewing information table 114. Next, according to the content ID 1143 of the content being viewed, a key word 1134 of the content being viewed is obtained from the content information table 113. Finally, referring to the “preference category table”, the measurement information delivering part 103 specifies a preference category of the key word 1134 of the content being viewed, and calculates the number of appearances of the preference category being specified. Then, the most frequently appeared preference category is assumed as the preference information 1103 of the user, and it is stored in the user information table 110 to update the table.

It is to be noted that any of the measuring server 1 and the Web server 3 may perform a processing for generating the user's preference information.

### Second Embodiment

In the first embodiment described above, every time when the Web site is accessed, the information of the content being viewed at that time is transmitted to the measuring server 1. However, there may be a case that the content displayed are changed to different ones while browsing several Web screens and Web sites. In the case above, it is necessary to establish association between the content having been viewed and subsequent browsing of a series of Web sites. In the second embodiment, an explanation will be made regarding a method to establish association between the content having been viewed and subsequent browsing of Web site series, by using the “viewing ID”.

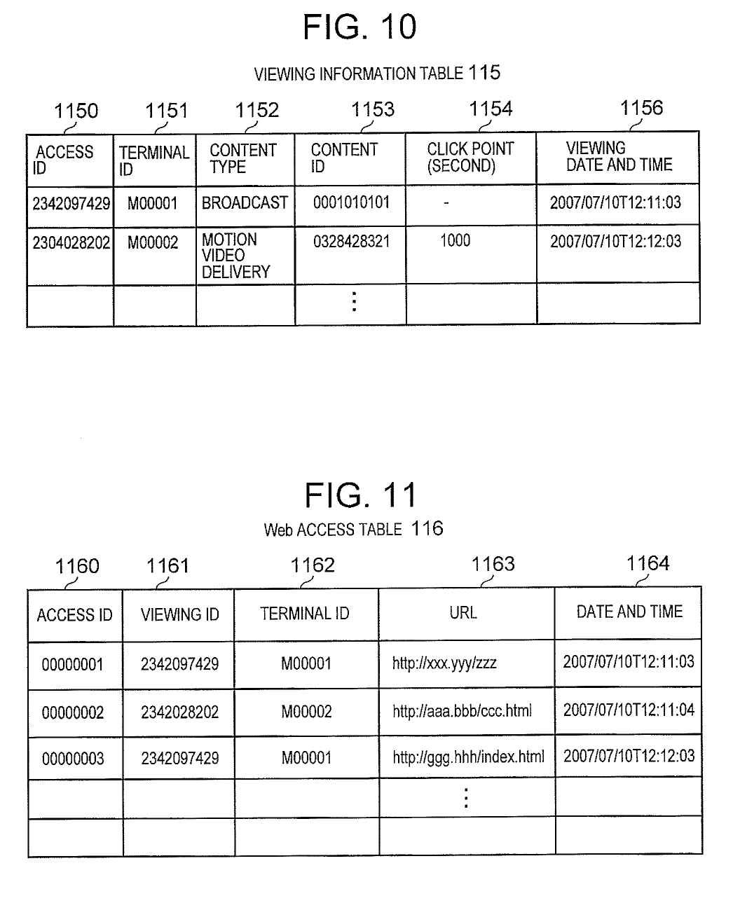

Basic configuration of the viewing effect measuring system according to the second embodiment is the same as the configuration of the first embodiment (FIG. 1). However, it is to be noted that the measuring server 1 of the second embodiment stores the viewing information table 115 as shown in FIG. 10, and the Web access table 116 as shown in FIG. 11, instead of the viewing information table 114.

In the viewing information table 115 as shown in FIG. 10, the column of URL 1145 is deleted, when compared with the viewing information table 114 of the first embodiment. The Web access table 116 is a table which stores following information in one record; an access ID 1160, a viewing ID 1161, a terminal ID 1162, a URL 1163, a date and time 1164, and the like. In other words, information as to accessing multiple Web sites (URL 1163) is stored in association with one viewing ID 1161.

Hereinafter, a flow of operation of the viewing effect measuring system according to the second embodiment will be explained. The preconditions are the same as the first embodiment.

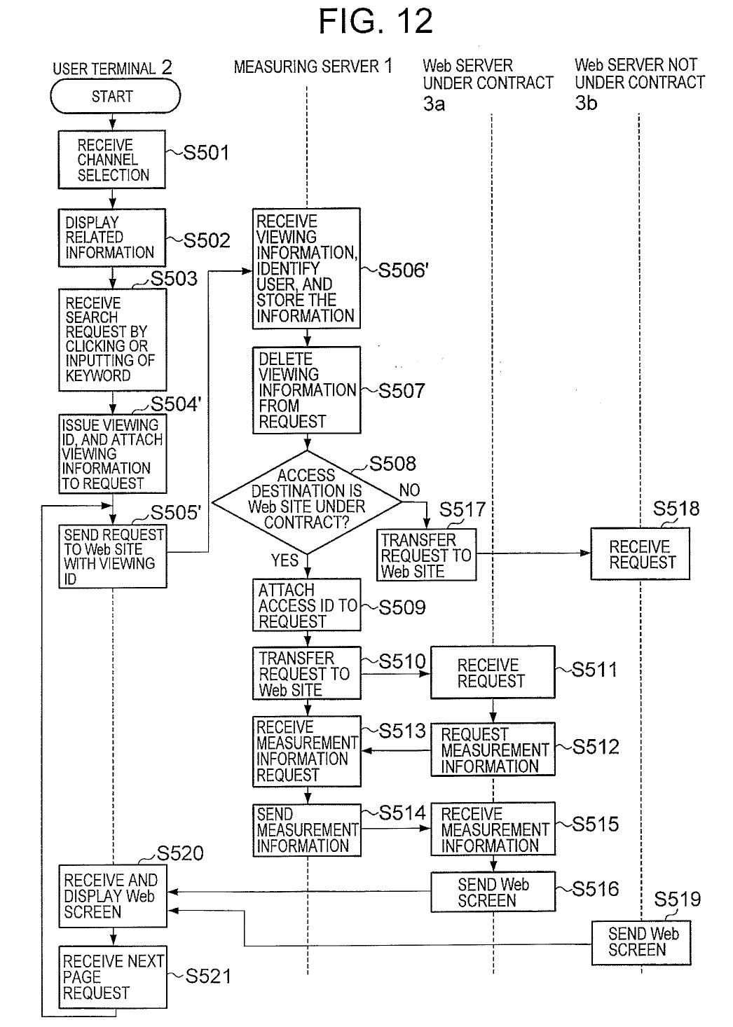

FIG. 12 shows a flow diagram relating to the second embodiment.

The processes from the channel selection (S501) to the search request receipt (S503) are the same as those of the aforementioned first embodiment.

The user terminal 2, which has received the search request, issues a viewing ID and attaches the viewing ID to the search request together with the viewing information (S504′).

Here, the viewing ID is an ID to identify the access to a series of Web sites while viewing the content and the viewing ID is made up of serial numbers or a random character string being sufficiently long. An available period is set to the viewing ID, and when a predetermined available period has elapsed (e.g., five minutes) from the time of previous accessing to the Web site, the viewing ID is made invalid, and a new ID is reissued. Even within the available period, in the case where the channel of the viewing content is changed and the process from S501 is restarted, or in the case where a search request designating a new URL is made and the process from S503 is restarted, a new viewing ID is issued assuming that the content or the scene viewed by the user have been changed to another.

Next, the viewing information sending part 205 of the user terminal 2 transmits to the Web server 3, the search request to which the viewing ID and the viewing information are attached (S505′). As in the case with the first embodiment, the measuring server 1 is set as a proxy server in the browser 202, and the search request to the Web server 3 is transmitted via the measuring server 1.

The viewing information receiving part 102 of the measuring server 1 receives from the user terminal 2, the search request to the Web server 3, to which the viewing ID and the viewing information are attached. Then, the client identifying part 101 identifies the user terminal 2 according to a known method.

Furthermore, the viewing information receiving part 102 adds one record to each of the viewing information table 115 and to the Web access table 116 (see FIG. 10 and FIG. 11). Then, the viewing information receiving part 102 issues and stores the access ID 1150 and the access ID 1160 respectively in the tables. Further the received viewing information, the viewing ID, and the URL included in the search request are stored (S506′).

The subsequent processes from S507 to S521 are basically the same as those in the first embodiment.

However, there are some differences in the way how to generate the measurement information and make the transmission in S514. In S514, the content that triggered an access to the Web site are specified before generating the measurement information. This is because, there may be a possibility that the content that triggered the user's search request has already disappeared at the time of current access requesting point of time, and unrelated content may be displayed.

Specifically, the measurement information delivering part 103 firstly specifies in S514, a record in the Web access table 116, having the access ID that corresponds to the one designated by the measurement information request from the Web server 3a. Then, the measurement information delivering part 103 specifies the viewing ID 1161 stored in the record and extracts from the Web access table 116, a record having the same viewing ID with the specified viewing ID 1161. Out of the records being extracted, a record having the earliest date and time 1164 is further extracted and the access ID 1160 of the record is specified. Then, a record in the viewing information table 115 is specified, the record being associated with the access ID 1160. This specified record has to be a record of the content that were displayed at the point of time when the search request was initially issued, which triggered the access to the series of sites.

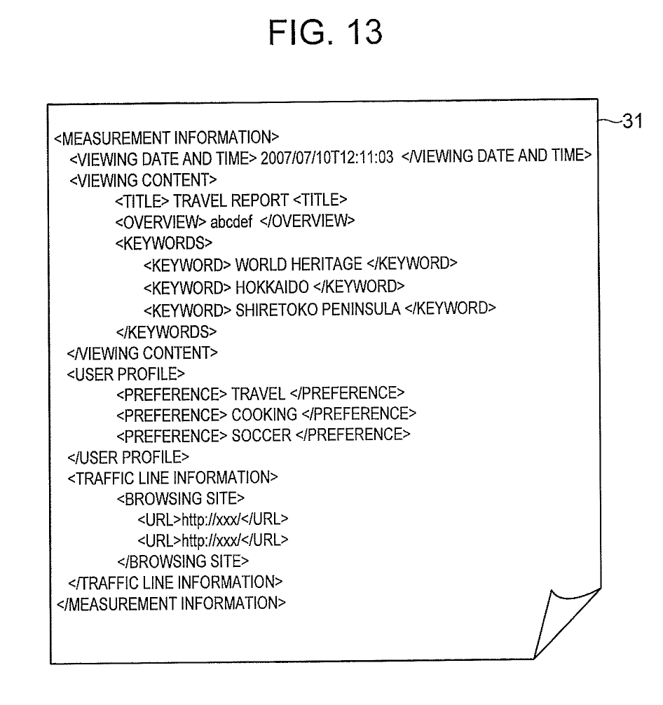

As shown in FIG. 13, the measurement information delivering part 103 incorporates in the measurement information 31, as the “viewing content” which triggered the access, the viewing information (the content type 1152, content ID 1153, click point 1154, and viewing date and time 1156) of the record specified above. In addition, the measurement information delivering part 103 incorporates in the measurement information 31, as the “user information (user profile)”, the user information being identified according to the terminal ID 1151 of the record being specified, in the same manner as the above first embodiment.

The measurement information delivering part 103 specifies each URL 1163 of multiple Web sites to which access has been made so far, out of the multiple records with the same viewing ID extracted from the Web access table 116, and incorporates the specified URL 1163 in the measurement information 31 as “traffic line information”.

When the user terminal 2 accepts a request of next page (S521), the process proceeds with S505′, assuming that it is an access to the Web site while viewing the same content, and an viewing ID being the same as the previous ID is attached to the search request, and the search request is transmitted to the measuring server 1. Accordingly, it is possible to perform processing assuming that this is the access to a series of the Web sites.

The second embodiment has been explained in the description above. According to the present embodiment, the content being viewed are managed in association with subsequent browsing of Web site series. Therefore, it is possible to measure and utilize the relationship between the content being viewed and the access to the Web sites more accurately.

### Third Embodiment

In the first embodiment and in the second embodiment, there has been described an example that the terminal on the user side simultaneously performs two functions; a content viewing terminal and a Web viewing terminal. On the other hand, in the third embodiment, there will be explained a case where the content viewing terminal and the Web viewing terminal independently exist as a system on the user side.

In the third embodiment, an explanation will be made as to a case where an association is established between the Web terminal and the content viewing terminal, and information relating to the content being viewed is displayed on the Web terminal. In the third embodiment, the measuring server 1 does not serve as a proxy server to relay a search request from the user terminal 2 to the Web server 3, but a broadcast receiving apparatus (referred to as “set-top box”) relays the search request from the Web terminal 8 to the Web server 3, and simultaneously transmits the viewing information to the measuring server 1.

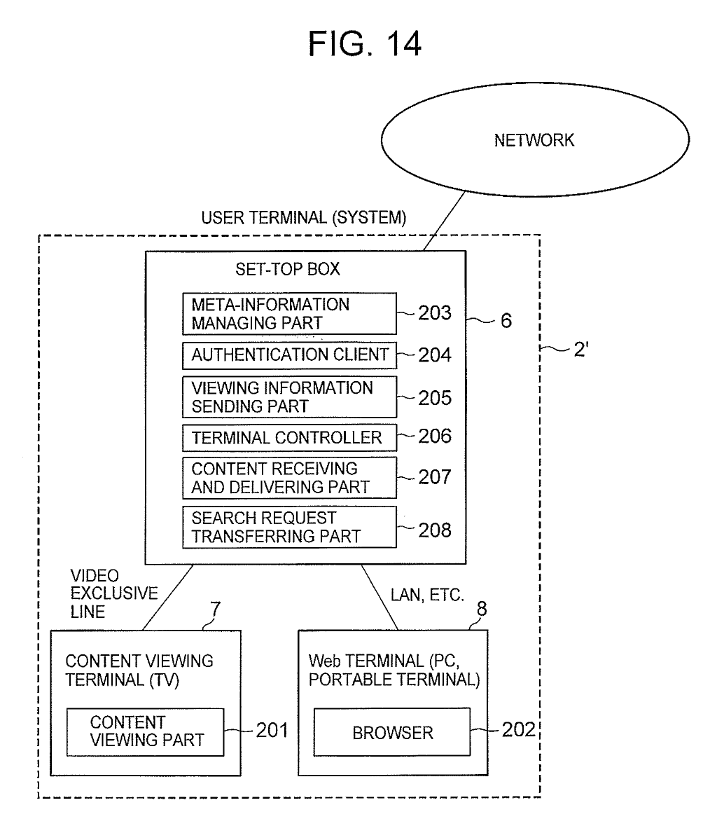

FIG. 14 illustrates a configuration of the viewing effect measuring system on the user terminal side according to the third embodiment. The other configurations (the measuring server 1, the Web server 3, the broadcast station 4, the distribution server 9, and the like) are the same as those of the first embodiment as shown in FIG. 1.

The user terminal 2′ incorporates the set-top box 6, a content viewing terminal 7 such as a TV terminal, and a Web terminal 8 such as a personal computer (referred to as “PC”) and a portable terminal.

Also in the third embodiment, the content may be delivered from the broadcast station 4, or the content may be delivered to the content viewing terminal 7 via the set-top box 6, from the distribution server 9 that is coupled with the network 5. Hereinafter, an explanation will be made, taking as an example the case where the content are delivered from the distribution server 9.

A carrier who operates the distribution server 9 may be the same as a carrier of the measuring server 1, a carrier of the Web site, or other carrier.

In addition, the set-top box 6 is coupled to the network 5. In addition, a video exclusive line and the LAN (Local Area Network) may couple the content viewing terminal 7 with the set-top box 6, and the Web terminal 8 with the set-top box 6.

The configurations of the set-top box 6, the content viewing terminal 7, and the Web terminal 8 may be the same as the configuration of the measuring server 1, except that the programs in the storage device are different. Then, the CPU executes the programs included in each of the elements, thereby implementing functions provided by each of the elements on the computer. It is further possible that those functions may be implemented by hardware.

The set-top box 6 incorporates functional elements; the meta-information managing part 203, the authentication client 204, and the viewing information sending part 205, which are similar to those described in the first embodiment. The set-top box 6 further incorporates a terminal controller 206 for managing related information between the content viewing terminal 7 and the Web terminal 8, a content receiving and delivering part 207 for receiving the content from the content distribution server 9 according to a user request and sends the content to the content viewing terminal, and a search request transferring part 208 for transferring the search request.

The content viewing terminal 7 incorporates the content viewing part 201, as in the case with the first embodiment.

The Web terminal 8 incorporates the browser 202, as in the case with the first embodiment.

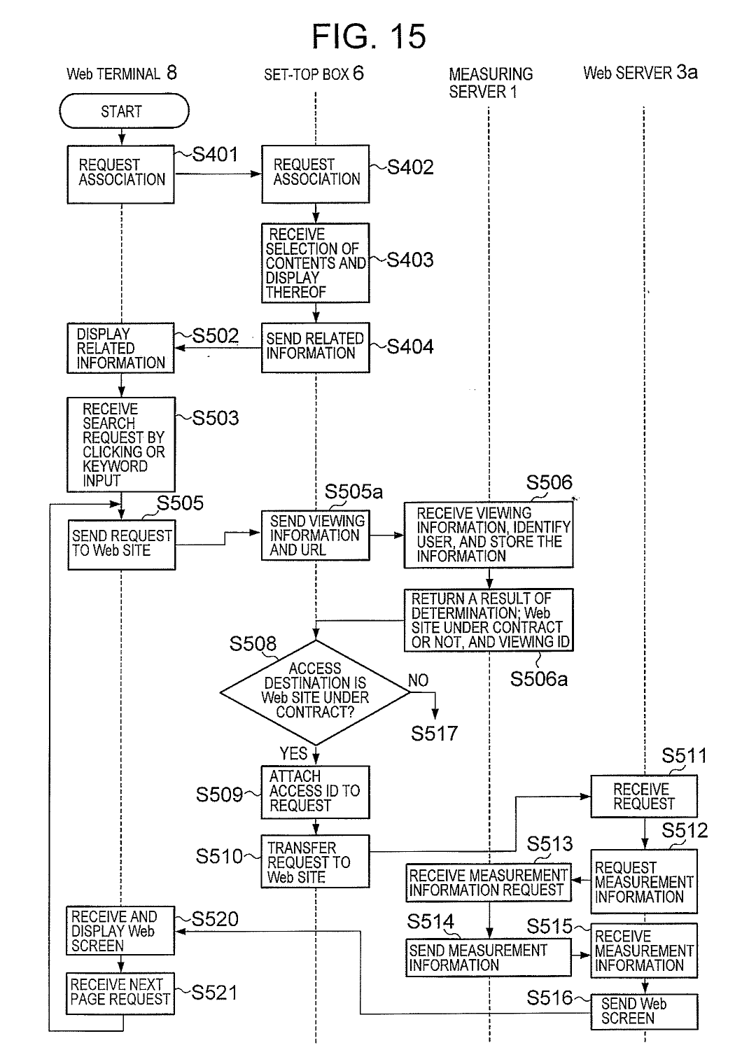

Hereinafter, a flow of the viewing effect measuring system according to the third embodiment will be explained. The preconditions are the same as those of the first embodiment. FIG. 15 illustrates a flow relating to the third embodiment.

Firstly, the browser 202 of the Web terminal 8 makes a request to the set-top box 6 to establish associations with the content viewing terminal 7 (S401). The terminal controller 206 of the set-top box 6 which accepted this request registers information regarding the associations (S402). It is assumed here that the processing to establish the associations is performed by an already-known method for establishing associations among multiple terminals by using SIP (Session Initiation Protocol) for instance.

Next, upon receipt of a request to display the content from a user via the controller 24 or the like, the content receiving and delivering part 207 of the set-top box 6 receives the content from the distribution server 9 and sends the content to the content viewing terminal 7 to display the content (S403). As in the case with the step S502 described in the first embodiment, the content receiving and delivering part 207 generates information related to the content being viewed, and by using the information of the association between the content viewing terminal 7 and the Web terminal 8, transmits the related information to the Web terminal 8 with which the content viewing terminal is associated (S404).

In receipt of the transmission, the Web terminal 8 displays the related information (S502).

Next, as in the case with the step S503 described in the first embodiment, upon receipt of a search request from the user to the Web server 3 of the Web site (S503), the Web terminal 8 sends the search request to the Web server 3 (S505). It is to be noted here that in contrast to the first and the second embodiments, the set-top box is assumed as a proxy server in the settings of the browser 202, whereby the request to the Web server 3 is transmitted via the set-top box 6.

The search request transferring part 208 of the set-top box 6 that has received the search request to the Web server 3 transmits the viewing information and URL of the search request to the measuring server 1 (S505a).

Upon receipt of the viewing information and URL information of the search request, just like the step S506 described in the first embodiment, the viewing information receiving part 102 of the measuring server 1 generates the access ID 1140, and stores the information in the viewing information table 114 (S506).

Next, the viewing information receiving part 102 determines whether or not the domain of the destination URL of the search request is a domain of the Web site under contract, and returns the determination result and the access ID 1140 to the set-up box 6 (S506a).

Next, as in the case with the processing from S508 to S510 of the first embodiment, the search request transferring part 208 of the set-top box 6 determines whether or not the destination Web server 3 is the Web server 3a under contract (S508), and if it is the Web server 3a under contract, the search request transferring part attaches the access ID 1140 to the search request (S509), and transmits the search request to the Web server 3 (S510). On the other hand, if the destination Web server 3 is not the Web server 3a under contract, just like the first embodiment, the processing performs the steps from S517.

The subsequent processing S520 and S521 are the same as the steps S520 and S521 of the first embodiment.

The third embodiment has been explained as described above. As discussed, even when the content viewing terminal and the Web viewing terminal are separated, the measuring server 1 collects the access information to the Web sites while the user is viewing the content, and the access information can be utilized effectively.

The specification and drawings are, accordingly, to be regarded in an illustrative rather than a restrictive sense. It will, however, be evident that various modifications and changes may be made thereto without departing from the spirit and scope of the invention as set forth in the claims.

What is claimed is:

1. A viewing effect measuring system comprising a user terminal, a measuring server, and a Web server, wherein,
the user terminal performs;
a content output process for receiving content from a content delivery apparatus which delivers content, and outputting the content,
a Web site displaying process for accepting a request to access a Web site, while the content are outputted by the content output process, accessing the Web site via a network, and displaying the Web site in such a manner as available for browsing, and
a measurement information sending process for establishing an association between Web site specifying information which identifies the Web site as to which the access is requested, and content specifying information which identifies the content being outputted when the access is performed, and sending information of the association as viewing information to the measuring server, and
the measuring server performs a process for receiving the viewing information from the user terminal and sending the information to the Web server of the Web site as measurement information.

2. The viewing effect measuring system according to claim 1, wherein,
the user terminal attaches a viewing ID to the viewing information to identify a viewing of the content which triggers the access, and sends the viewing information to the measuring server, and
the measuring server generates the measurement information from the viewing information collected from the user terminal, assuming that the viewing information to which an identical viewing ID is attached as having the same content that triggers the access.

3. The viewing effect measuring system according to claim 1, wherein,
the measuring server stores user information, and
the measurement information sending process sends to the Web server of the Web site, the measurement information in association with the user information.

4. The viewing effect measuring system according to claim 1, wherein,
the measuring server sends the measurement information to the Web server in real time, in response to a request from the Web server of the Web site.

5. The viewing effect measuring system according to claim 1, wherein,
the measuring server generates the measurement information including information related to multiple accesses, by using the viewing information collected within a predetermined period of time.

6. The viewing effect measuring system according to claim 1, wherein,
the user terminal comprises,
a content viewing apparatus which allows viewing of the content,
a Web terminal which allows displaying the Web site, and
a terminal controller for establishing an association between the content viewing apparatus and the Web terminal and managing those elements, wherein,
the terminal controller acquires information of the content being displayed on the content viewing apparatus when the Web site is displayed on the Web terminal, and sends the information to the measuring server as the viewing information.

7. A viewing effect measuring method of a viewing effect measuring system comprising a user terminal, a measuring server, and a Web server, wherein,
the user terminal performs;
a content output process for receiving content from a content delivery apparatus which delivers content, and outputting the content,
a Web site displaying process for accepting a request to access a Web site, while the content are outputted by the content output process, accessing the Web site via a network, and displaying the Web site in such a manner as available for browsing, and
a measurement information sending process for establishing an association between Web site specifying information which identifies the Web site as to which the access is requested, and content specifying information which identifies the content being outputted when the access is performed, and sending information of the association as viewing information to the measuring server, and
the measuring sever performs a process for receiving the viewing information from the user terminal and sending the information to the Web server of the Web site as measurement information.

8. The viewing effect measuring method of the viewing effect measuring system according to claim 7, wherein,
the user terminal attaches a viewing ID to the viewing information to identify a viewing of the content which triggers the access, and sends the viewing information to the measuring server, and
the measuring server generates the measurement information from the viewing information collected from the user terminal, assuming that the viewing information to which an identical viewing ID is attached as having the same content that triggers the access.

9. A terminal available for being coupled with a measuring server for measuring a viewing effect, the terminal performing;
a content output process for receiving content from a content delivery apparatus which delivers content, and outputting the content,
a Web site displaying process for accepting a request to access a Web site, while the content are outputted by the content output process, accessing the Web site via a network, and displaying the Web site in such a manner as available for browsing, and
a measurement information sending process for establishing an association between Web site specifying information which identifies the Web site as to which the access is requested, and content specifying information which identifies the content being outputted when the access is performed, and sending information of the association as viewing information to the measuring server.

10. The terminal according to claim 9, further performing a process for;
attaching a viewing ID to the viewing information for identifying a viewing of the content that triggers the access, and sending the viewing information to the measuring server.

11. A measuring server in a viewing effect measuring system comprising a user terminal, the measuring server, and a Web server, the measuring server performing the process for;
receiving from the user terminal, viewing information in which Web site specifying information for specifying a Web site as to which an access is requested is associated with content specifying information for specifying the content outputted when the access is made, and
sending the viewing information as measurement information to the Web server of the Web site.

12. The measuring server in the viewing effect measuring system according to claim 11, the measuring server performing the process for;
receiving from the user terminal, the viewing information to which a viewing ID is attached for identifying a viewing of the content that triggers the access, and
generating the measurement information from the viewing information being received, assuming that the viewing information to which an identical viewing ID is attached as having the same content that triggers the access.
